(19) United States
(12) Patent Application Publication
(10) Pub. No.: US 2005/0088755 A1
(43) Pub. Date: Apr. 28, 2005

(54) Zoom lens system

(75) Inventor: Takashi Enomoto, Chiba (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/969,969

(22) Filed: Oct. 22, 2004

(30) Foreign Application Priority Data
Oct. 23, 2003 (JP) 2003-362642

(51) Int. Cl. G02B 15/14

(52) U.S. Cl. 359/686

(57) ABSTRACT

A zoom lens system includes a first lens group, a second lens group, a third lens group and a fourth lens group. Zooming is performed by moving each lens group in the optical axis direction. The zoom lens system satisfies the following conditions:
0.35<log(f_{T23}/f_{W23})/log(fₜ/f_{w})<0.55 (1);
0.4<(LD_{W}−LD_{T})/(fₜ/f_{w})<0.7 (2); wherein
f_{23W}: the combined focal length of the second and the third lens groups at the short focal length extremity;
f_{23T}: the combined focal length of the second and the third lens groups at the long focal length extremity;
fₜ: the focal length of the entire zoom lens system at the long focal length extremity;
f_{w}: the focal length of the entire zoom lens system at the short focal length extremity;
LD_{w}: the distance from the most object-side surface of the first lens group to the most image-side surface of the fourth lens group at the short focal length extremity; and
LD_{T}: the distance from the most object-side surface of the first lens group to the most image-side surface of the fourth lens group at the long focal length extremity.

### BACKGROUND OF THE INVENTION

1. Field of the Invention

The present invention relates to a zoom lens system which is used in a photographing camera such as a lens shutter camera.

2. Description of the Prior Art

A zoom lens system of a compact camera does not require a long back focal distance, unlike a zoom lens system of a single lens reflex (SLR) camera which requires a space to provide a mirror behind the photographing lens system.

As a zoom lens system of a compact camera in which there is no need to consider a back focal distance, a zoom lens system of three-lens-group arrangement, e.g., a first lens group having a positive refractive power, a second lens group having a positive refractive power, and a third lens group having a negative refractive power, in this order from the object, has been often employed in the case of a zoom lens system with a zoom ratio of more than 3, as shown in Japanese Unexamined Patent Publication (hereinafter, JUPP) No. Hei-2-256015.

In such a zoom lens system of the three-lens-group arrangement, if an attempt is made to increase a zoom ratio, the traveling distance of lens groups becomes longer, and the size of the zoom lens system becomes lager.

On the other hand, in the zoom lens system of the three-lens-group arrangement, if an attempt is made to strengthen the refractive power of lens groups so that the traveling distances of lens groups become shorter, the number of lens elements increases in order to correct aberrations in each lens group. Consequently, the total thickness of all the lens groups inevitably increases; thereby, the thickness of the camera when the zoom lens barrel (zoom lens system) is fully retracted is increased, and further miniaturization of the camera body, i.e., obtaining a thin camera body, cannot be achieved.

For the purpose of materializing a higher zoom ratio and a smaller zoom lens system, a zoom lens system of four-lens-group arrangement, i.e., a first lens group having a positive refractive power (hereinafter, a positive first lens group), a second lens group having a negative refractive poser (hereinafter, a negative second lens group), a third lens group having a positive refractive power (hereinafter, a positive third lens group) and a fourth lens group having a negative refractive power (hereinafter, a negative fourth lens group), in this order from the object, has been disclosed in, e.g., JUPP No.Hei-6-265788 and JUPP No.2000-180725. However, the zoom lens systems disclosed in these publications do not sufficiently attain a higher zoom ratio and further miniaturization of a zoom lens system.

### SUMMARY OF THE INVENTION

The present invention achieves a higher zoom ratio and further miniaturization in a zoom lens system of the four-lens-group arrangement, i.e., a positive lens group, a negative lens group, a positive lens group, and a negative lens group, in this order from the object.

According to an aspect of the present invention, there is provided a zoom lens system including a positive first lens group, a negative second lens group, a positive third lens group, and a negative fourth lens group, in this order from the object.

Zooming is performed by moving each lens group in the optical axis-direction.

The zoom lens system satisfies the following conditions:
0.35<log(f_{T23}/f_{W23})/log(fₜ/f_{w})<0.55 (1)
0.4<(LD_{W}−LD_{T})/(fₜ/f_{w})<0.7 (2)
wherein
f_{23W} designates the combined focal length of the negative second lens group and the positive third lens group at the short focal length extremity;
f_{23T} designates the combined focal length of the negative second lens group and the positive third lens group at the long focal length extremity;
fₜ designates the focal length of the entire zoom lens system at the long focal length extremity;
f_{w} designates the focal length of the entire zoom lens system at the short focal length extremity;
LD_{w} designates the distance from the most object-side surface of the positive first lens group to the most image-side surface of the negative fourth lens group at the short focal length extremity; and
LD_{T} designates the distance from the most object-side surface of the positive first lens group to the most image-side surface of the negative fourth lens group at the long focal length extremity.

The zoom lens system of the present invention preferably satisfies the following condition:
0.7<f_{w}/f_{1G}<0.9 (3)
wherein
f_{w} designates the focal length of the entire zoom lens system at the short focal length extremity; and
f_{1G} designates the focal length of the positive first lens group.

The zoom lens system of the present invention can satisfy the following condition:
0.05<(d_{23W}−d_{23T})/f_{W}<0.2 (4)
wherein
d_{23W} designates the distance between the negative second lens group and the positive third lens group, i.e., the most image-side surface of the negative second lens group and the most object-side surface of the positive third lens group, at the short focal length extremity; and
d_{23T} designates the distance between the negative second lens group and the positive third lens group, i.e., the most image-side surface of the negative second lens group and the most object-side surface of the positive third lens group, at the long focal length extremity; and
f_{w} designates the focal length of the entire zoom lens system at the short focal length extremity.

Furthermore, the zoom lens system of the present invention preferably satisfies the following condition:
11<(TL_{T}−TL_{W})/(fₜ/f_{w})<14 (5)
wherein
TL_{W} designates the distance from the most object-side surface of the positive first lens group to the image plane, at the short focal length extremity;
TL_{T} designates the distance from the most object-side surface of the positive first lens group to the image plane, at the long focal length extremity;
fₜ designates the focal length of the entire zoom lens system at the long focal length extremity; and
f_{w} designates the focal length of the entire zoom lens system at the short focal length extremity.

The zoon lens system of the present invention is arranged to have at least one aspherical surface in the positive third lens group for particularly correcting spherical aberration; and the aspherical surface preferably satisfies the following condition:
−40<ΔIₐₛₚ<−10 (6)
wherein
ΔIₐₛₚ designates the amount of change of the spherical aberration coefficient due to the aspherical surface in the positive third lens group under the condition that the focal length at the short focal length extremity is converted to 1.0.

The zoon lens system of the present invention is arranged to have at least one aspherical surface in the negative fourth lens group for particularly correcting distortion; and the aspherical surface preferably satisfies the following condition:
0<ΔVₐₛₚ<3 (7)
wherein
ΔVₐₛₚ designates the amount of change of the distortion coefficient due to the aspherical surface in the negative fourth lens group under the condition that the focal length at the short focal length extremity is converted to 1.0.

The present disclosure relates to subject matter contained in Japanese Patent Application No. 2003-362642 (filed on Oct. 23, 2003) which is expressly incorporated herein in its entirety.

### BRIEF DESCRIPTION OF THE DRAWINGS

The present invention will be discussed below in detail with reference to the accompanying drawings, in which:

FIG. 1 is a lens arrangement of the zoom lens system according to a first embodiment of the present invention;

FIGS. 2A, 2B, 2C and 2D show aberrations occurred, at the short focal length extremity, in the lens arrangement shown in FIG. 1;

FIGS. 3A, 3B, 3C and 3D show aberrations occurred, at an intermediate focal length, in the lens arrangement shown in FIG. 1;

FIGS. 4A, 4B, 4C and 4D show aberrations occurred, at the long focal length extremity, in the lens arrangement shown in FIG. 1;

FIG. 5 is a lens arrangement of the zoom lens system according to a second embodiment of the present invention;

FIGS. 6A, 6B, 6C and 6D show aberrations occurred, at the short focal length extremity, in the lens arrangement shown in FIG. 5;

FIGS. 7A, 7B, 7C and 7D show aberrations occurred, at an intermediate focal length, in the lens arrangement shown in FIG. 5;

FIGS. 8A, 8B, 8C and 8D show aberrations occurred, at the long focal length extremity, in the lens arrangement shown in FIG. 5;

FIG. 9 is a lens arrangement, at the short focal length extremity, of the zoom lens system according to a third embodiment of the present invention;

FIGS. 10A, 10B, 10C and 10D show aberrations occurred in the lens arrangement shown in FIG. 9;

FIGS. 11A, 11B, 11C and 11D show aberrations occurred in the lens arrangement shown in FIG. 9 at a first intermediate focal length ((fm); before switching);

FIGS. 12A, 12B, 12C and 12D show aberrations occurred in the lens arrangement shown in FIG. 9 at a second intermediate focal length ((fm′) ;after switching);

FIG. 13 is a lens arrangement, at the long focal length extremity, of the zoom lens system according to the third embodiment of the present invention;

FIGS. 14A, 14B, 14C and 14D show aberrations occurred in the lens arrangement shown in FIG. 13;

FIG. 15 is another schematic view of the lens-group moving paths for the third embodiment; and

FIG. 16 is a schematic view of the lens-group moving paths for the first and second embodiments.

### DESCRIPTION OF THE PREFERRED EMBODIMENTS

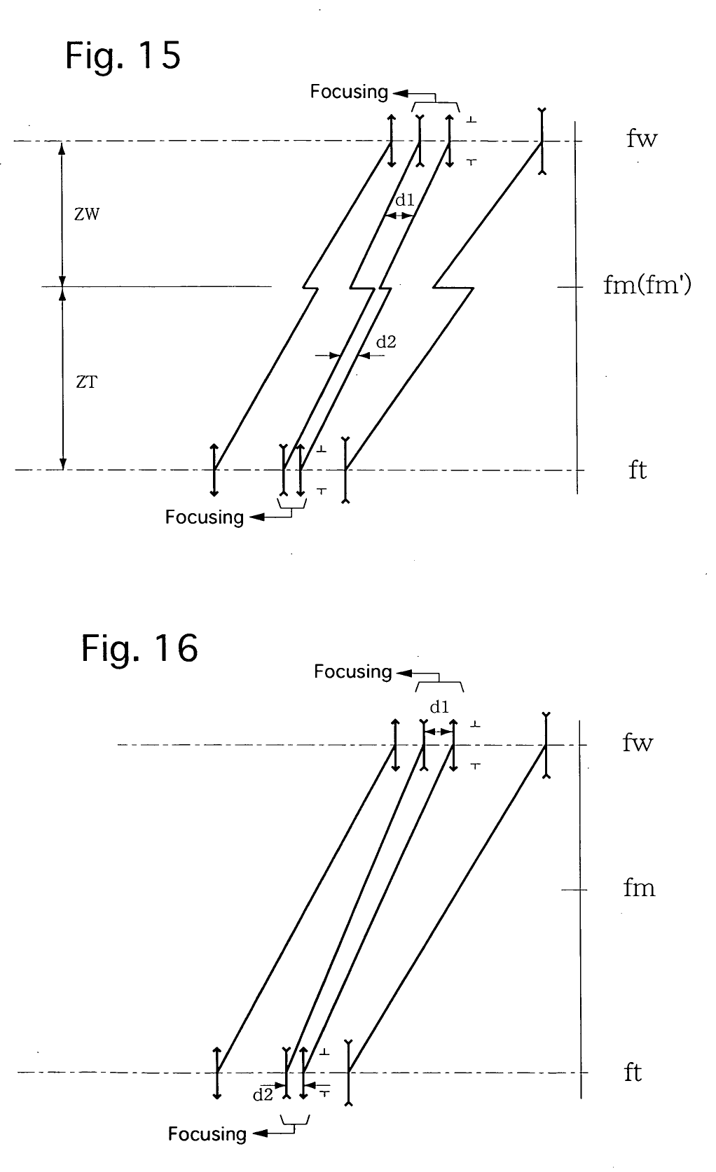

As shown in the lens-group moving paths of FIGS. 15 and 16, the four-lens-group zoom lens system for a compact camera includes a positive first lens group 10, a negative second lens group 20, a positive third lens group 30, and a negative fourth lens group 40, in this order from the object.

Zooming is performed by moving the first through fourth lens groups in the optical axis direction.

A diaphragm S is provided between the positive third lens group 30 and the negative fourth lens group 40, and moves together with the positive third lens group 30.

In regard to the schematic views of the lens-group moving paths of FIGS. 15 and 16, FIG. 15 is an example of the lens-group moving paths having a switching movement of the lens groups at the intermediate focal lengths. According to FIG. 15, in zooming from the short focal length extremity fw toward the long focal length extremity ft, the lens groups 10 through 40 are arranged to move as follows:

In a focal-length range ZW (the first focal length range; the short-focal-length side zooming range) from the short focal length extremity fw to the first intermediate focal length fm, the positive first lens group 10, the negative second lens group 20, the positive third lens group 30, and the negative fourth lens group 40 are moved toward the object;

At the first intermediate focal length fm (before switching), the positive first lens group 10, the negative second lens group 20, the positive third lens group 30, and the negative fourth lens group 40 are moved towards the image by a predetermined distance, so that the first intermediate focal length fm is changed to the second intermediate focal length fm′ (after switching);

In a focal-length range ZT (the second focal length range; the long-focal-length side zooming range) from the second intermediate focal length fm′ to the long focal length extremity ft, the positive first lens group 10, the negative second lens group 20, the positive third lens group 30, and the negative fourth lens group 40 are moved towards the object;

In the focal-length range ZW, the negative second lens group 20 and the positive third lens group 30 maintains a first distance d1 (the first state);

At the first intermediate focal length fm, the distance between the negative second lens group 20 and the positive third lens group 30 is reduced from the first distance d1; and

In the focal-length range ZT, the negative second lens group 20 and the positive third lens group 30 maintain the second distance d2 (the second state).

The first intermediate focal length fm belongs to the first focal length range ZW.

The second intermediate focal length fm′ is determined after the following movement of the lens groups (i) and (ii) is completed:
(i) the positive first lens group 10 and the negative fourth lens group 40 are moved from the positions thereof, corresponding to the first intermediate focal length fm, toward the image; and
(ii) the negative second lens group 20 and the positive third lens group 30 reduce the distance therebetween.

Upon zooming, the diaphragm S moves together with the positive third lens group 30.

The lens-group-moving paths, before and after the switching movement, for the first through fourth lens groups shown in FIG. 15 are simply depicted as straight lines. It should however be noted that actual lens-group-moving paths are not necessarily straight lines. Furthermore, focusing is performed by integrally moving the negative second lens group 20 and the positive third lens group 30 regardless of the focal length ranges.

The lens-group-moving paths have discontinuities at the first intermediate focal length fm and the second intermediate focal length fm′; however, by adequately determining the positions of the positive first lens group 10, the negative second lens group 20, the positive third lens group 30, and the negative fourth lens group 40 respectively at the short focal length extremity fw, the first intermediate focal length fm, the second intermediate focal length fm′ and the long focal length extremity ft, solutions by which an image is correctly formed on the image plane can be obtained. According to the lens-group-moving paths with these solutions, a zoom lens system which is miniaturized and has a higher zoom ratio can be obtained.

Furthermore, positions for stopping each lens group can be determined in a stepwise manner along the lens-group moving paths of FIG. 15. In an actual mechanical arrangement of the zoom lens system, each lens group can be stopped at predetermined positions according to the above-explained stepwise manner.

For example, if positions at which each lens group is to be stopped are determined by appropriately selecting positions before or behind the first (second) intermediate focal length fm (fm′), i.e., not at the positions exactly corresponding to the first (second) intermediate focal length fm (fm′), the above discontinuities can be connected by smooth curved lines.

Moreover, if a stopping position closest to the second intermediate focal length fm′ in the long-focal-length side zooming range ZT is set closer to the object than to a stopping position closest to the first intermediate focal length fm in the short-focal-length side zooming range ZW, precision on the movement of the lens groups can be enhanced, since a U-turn movement is prevented in actual moving paths.

FIG. 16 shows an example of the lens-group moving paths without intermediate-switching of the focal lengths. Upon zooming from the short focal length extremity toward the long focal length extremity, all the lens groups move toward the object, while the distances therebetween are varied. The diaphragm S is provided between the positive third lens group 30 and the negative fourth lens group 40, and moves together with the positive third lens group 30. The lens-group moving paths of FIG. 16 are also simply depicted as straight lines; however actual lens-group moving paths are not necessarily straight lines.

Even if the lens-group moving paths of FIG. 16 are employed, the position of each lens group can be precisely controlled, so that a higher zoom ratio and further miniaturization can be achieved.

Condition (1) specifies the combined focal length of the negative second lens group 20 and the positive third lens group 30 at the short focal length extremity and the long focal length extremity, respectively. By satisfying this condition, the zoom ratio can be made larger, while an increase of the overall length of the zoom lens system is prevented.

If log(f_{T23/f}_{W23)/log(f}ₜ/f_{w}) exceeds the upper limit of condition (1) , the zooming function of the negative second lens group 20 and the positive third lens groups 30 becomes too large, so that aberrations in each of the negative second lens group 20 and the positive third lens group 30 become larger.

If log(f_{T23/f}_{W23)/log(f}ₜ/f_{w}) exceeds the lower limit of condition (1), it becomes difficult to achieve a higher zoom ratio.

Condition (2) specifies the overall length of the zoom lens system at the short focal length extremity and at the long focal length extremity.

If (LD_{W}−LD_{T})/(fₜ/f_{w}) exceeds the upper limit of condition (2), the traveling distance of each lens group becomes longer, so that further miniaturization of the zoom lens system cannot be achieved.

If (LD_{W}−LD_{T})/(fₜ/f_{w}) exceeds the lower limit of condition (2), it is difficult to sufficiently increase the zoom ratio, and the correcting of aberrations becomes difficult.

Condition (3) specifies the focal length (refractive power) of the positive first lens group 10 in order to shorten the traveling distance of the positive first lens group 10.

If f_{w}/f_{1G} exceeds the upper limit of condition (3), the refractive power of the positive first lens group 10 becomes too strong, and aberrations in the positive first lens group 10 increase to the extent that the correcting of the aberrations becomes impossible.

If f_{w}/f_{1G} exceeds the lower limit of condition (3), the refractive power of the positive first lens group 10 becomes weaker, so that the traveling distance of the positive first lens group 10 becomes longer. Consequently, further miniaturization of the zoom lens system cannot be attained.

Condition (4) specifies the distance between the negative second lens group 20 and the positive third lens group 30 at the short focal length extremity and the long focal length extremity, respectively. By satisfying this condition, the zoom ratio can be made higher without increasing the overall length of the zoom lens system.

If the difference between the distance defined by the negative second lens group 20 and the positive third lens group 30 at the short focal length extremity and the distance defined thereby at the long focal length extremity becomes larger to the extent that (d_{23W}−d_{23T})/f_{w} exceeds the upper limit of condition (4), the overall length of the zoom lens system becomes longer.

If the difference between the distance defined by the negative second lens group 20 and the positive third lens group 30 at the short focal length extremity and the distance defined thereby at the long focal length extremity becomes smaller to the extent that (d_{23W}−d_{23T})/f_{w} exceeds the lower limit of condition (4), it becomes difficult to make the zoom ratio higher.

Condition (5) specifies the change in the overall length of the zoom lens system at the short focal length extremity and the long focal length extremity. By satisfying this condition, further miniaturization of the zoom lens system can be attained.

If (TL_{T}−TL_{W})/(fₜ/f_{w}) exceeds the upper limit of condition (5), the change in the overall length of the zoom lens system at the short focal length extremity and the long focal length extremity becomes too large. Consequently, the overall length of the zoom lens system becomes longer, and the size of the zoom lens system undesirably becomes larger.

If (TL_{T}−TL_{W})/(fₜ/f_{w}) exceeds the lower limit of condition (5), sensitivity against aberrations with respect to each lens group becomes higher in order to make the traveling distance of each lens group shorter. Consequently, the correcting of aberrations becomes difficult.

Condition (6) specifies the amount of asphericity in the case where the positive third lens group 30 includes at least one aspherical surface. By satisfying this condition, spherical aberrations can be adequately corrected.

If ΔIₐₛₚ exceeds the upper limit of condition (6), the amount of asphericity becomes larger. Consequently, manufacture of the lens element having the aspherical surface becomes difficult.

If ΔIₐₛₚ exceeds the lower limit of condition (6), the effect of the correcting of spherical aberration by the aspherical surface cannot be achieved sufficiently.

Condition (7) specifies the amount of asphericity in the case where the negative fourth lens group 40 includes at least one aspherical surface. By satisfying this condition, distortion can be adequately corrected.

If ΔVₐₛₚ exceeds the upper limit of condition (7), the amount of asphericity becomes larger. Consequently, manufacture of the lens element having the aspherical surface becomes difficult.

If tΔVₐₛₚ exceeds the lower limit of condition (7), the effect of the correcting of distortion by the aspherical surface cannot be achieved sufficiently.

Specific numerical data of the embodiments will be described hereinafter. In the diagrams of chromatic aberration (axial chromatic aberration) represented by spherical aberration, the solid line and the two types of dotted lines respectively indicate spherical aberrations with respect to the d, g and C lines. Also, in the diagrams of lateral chromatic aberration, the two types of dotted lines respectively indicate magnification with respect to the g and C lines; however, the d line as the base line coincides with the ordinate. In the diagrams of astigmatism, S designates the sagittal image, and M designates the meridional image. In the tables, F_{NO} designates the f-number, f designates the focal length of the entire zoom lens system, f_{B} designates the back focal distance, W designates the half angle-of-view (°), r designates the radius of curvature, d designates the lens-element thickness or distance between lens elements, N_{d} designates the refractive index of the d-line, and v designates the Abbe number.

In addition to the above, an aspherical surface which is symmetrical with respect to the optical axis is defined as follows:
x=cy²/(1+[1−{1+K}c²y²]^{1/2})+A4y⁴+A6y⁶+A8y⁸+A10y¹⁰
wherein:
c designates a curvature of the aspherical vertex (1/r);
y designates a distance from the optical axis;
K designates the conic coefficient; and
A4 designates a fourth-order aspherical coefficient;
A6 designates a sixth-order aspherical coefficient;
A8 designates a eighth-order aspherical coefficient; and
A10 designates a tenth-order aspherical coefficient.

### EMBODIMENT 1

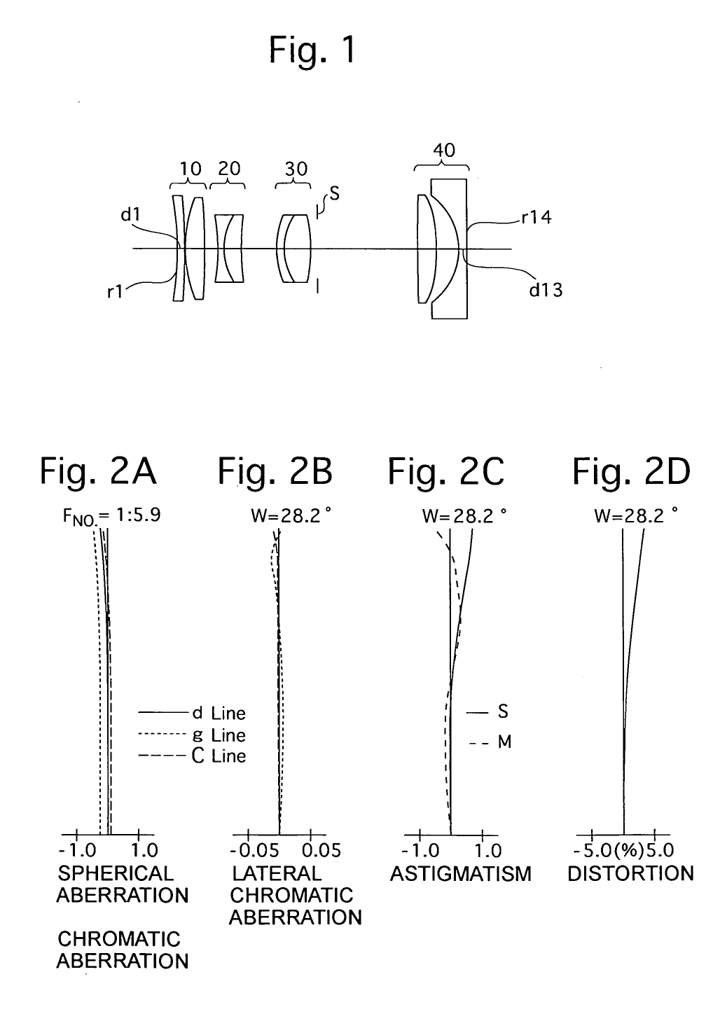

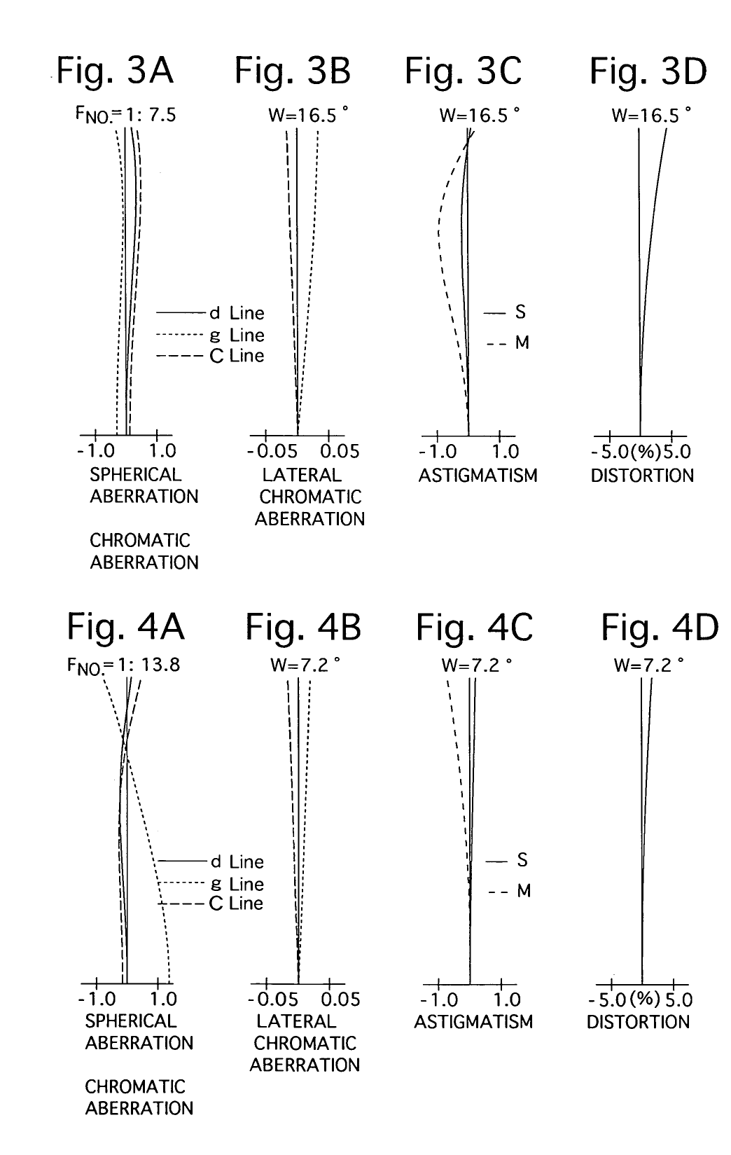

FIG. 1 is the lens arrangement of the zoom lens system according to the first embodiment of the present invention. The first embodiment corresponds to the lens-group moving paths shown in FIG. 16. FIGS. 2A through 2D show aberrations occurred, at the short focal length extremity (fw), in the lens arrangement shown in FIG. 1. FIG. 3A through 3D show aberrations occurred, at an intermediate focal length (fm), in the lens arrangement shown in FIG. 1. FIGS. 4A through 4D show aberrations occurred, at the long focal length extremity (ft), in the lens arrangement shown in FIG. 1. Table 1 shows the numerical data of the first embodiment.

Surface Nos. 1 through 4 constitute the positive first lens group 10, surface Nos. 5 through 7 constitute the negative second lens group 20, surface Nos. 8 through 10 constitute the positive third lens group 30, and surface Nos. 11 through 14 constitute the negative fourth lens group 40.

The diaphragm S is provided 1.0 mm behind (on the image plane side) the positive third lens group 30 (surface No. 10).

The positive first lens group 10 includes a negative lens element and a positive lens element, in this order from the object.

The negative second lens group 20 includes cemented lens elements having a biconcave negative lens element and a positive lens element, in this order from the object.

The positive third lens group 30 includes cemented lens elements having a negative meniscus lens element having the convex surface facing-toward the object and a positive lens element, in this order from the object.

The negative fourth lens group 40 includes a positive lens element and a negative lens element, in this order from the object.

TABLE 1

F_{NO} = 1:5.9-7.5-13.8
f = 39.00-70.00-168.00
W = 28.2-16.5-7.2
fB = 9.77-23.70-65.07

| Surface No. | r | d | Nd | ν |
|---|---|---|---|---|
| 1 | −48.125 | 1.10 | 1.84666 | 23.8 |
| 2 | −106.698 | 0.10 | | |
| 3* | 21.091 | 2.90 | 1.49700 | 81.6 |
| 4 | −107.528 | 2.00-7.52-18.36 | | |
| 5 | −29.303 | 0.90 | 1.82086 | 44.0 |
| 6 | 9.586 | 2.60 | 1.80518 | 25.4 |
| 7 | 38.947 | 5.30-2.50-0.30 | | |
| 8 | 13.975 | 1.10 | 1.84666 | 23.8 |
| 9 | 9.325 | 4.00 | 1.58636 | 60.9 |
| 10* | −21.997 | 16.02-11.36-2.20 | | |
| 11* | 155.461 | 2.80 | 1.58547 | 29.9 |
| 12* | −37.501 | 3.36 | | |
| 13 | −10.151 | 1.20 | 1.72916 | 54.7 |
| 14 | 1609.077 | — | | |

*designates the aspherical surface which is
rotationally symmetrical with respect to the optical axis.
Aspherical surface data (the aspherical surface
coefficients not indicated are zero (0.00)):

| Surf. No. | K | A4 | A6 | A8 |
|---|---|---|---|---|
| 3 | 0.00 | −0.75176 × 10⁻⁵ | −0.27663 × 10⁻⁷ | — |
| 10 | 0.00 | 0.64841 × 10⁻⁴ | −0.36596 × 10⁻⁶ | — |
| 11 | 0.00 | −0.12207 × 10⁻⁴ | −0.91503 × 10⁻⁶ | 0.12106 × 10⁻⁷ |
| 12 | 0.00 | −0.12100 × 10⁻³ | −0.57019 × 10⁻⁶ | — |

### EMBODIMENT 2

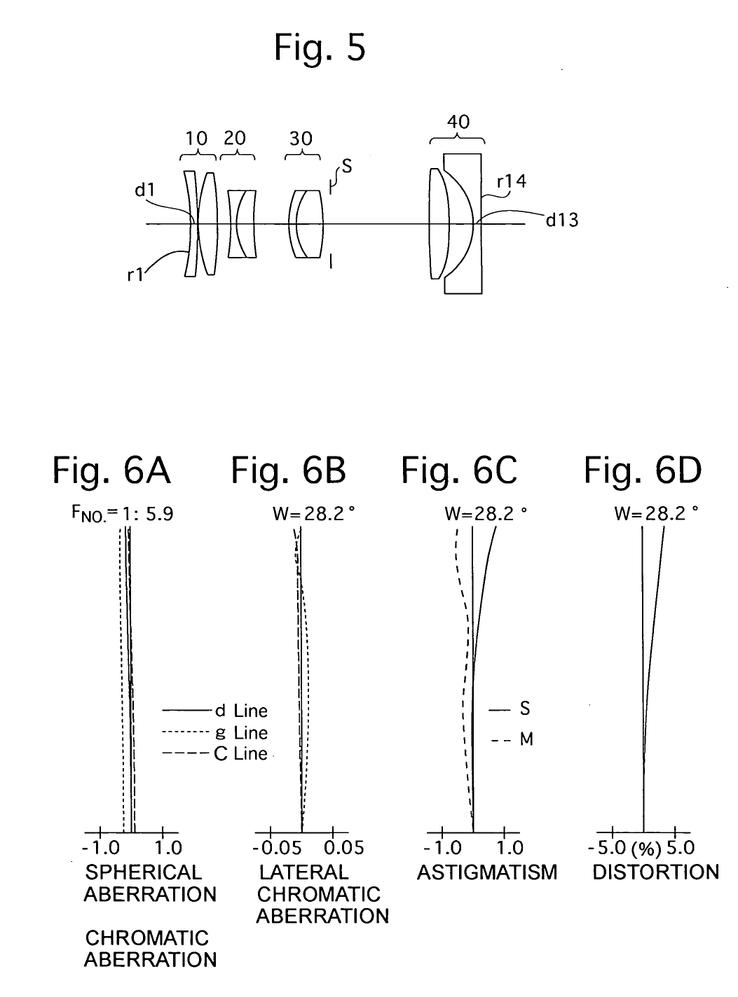

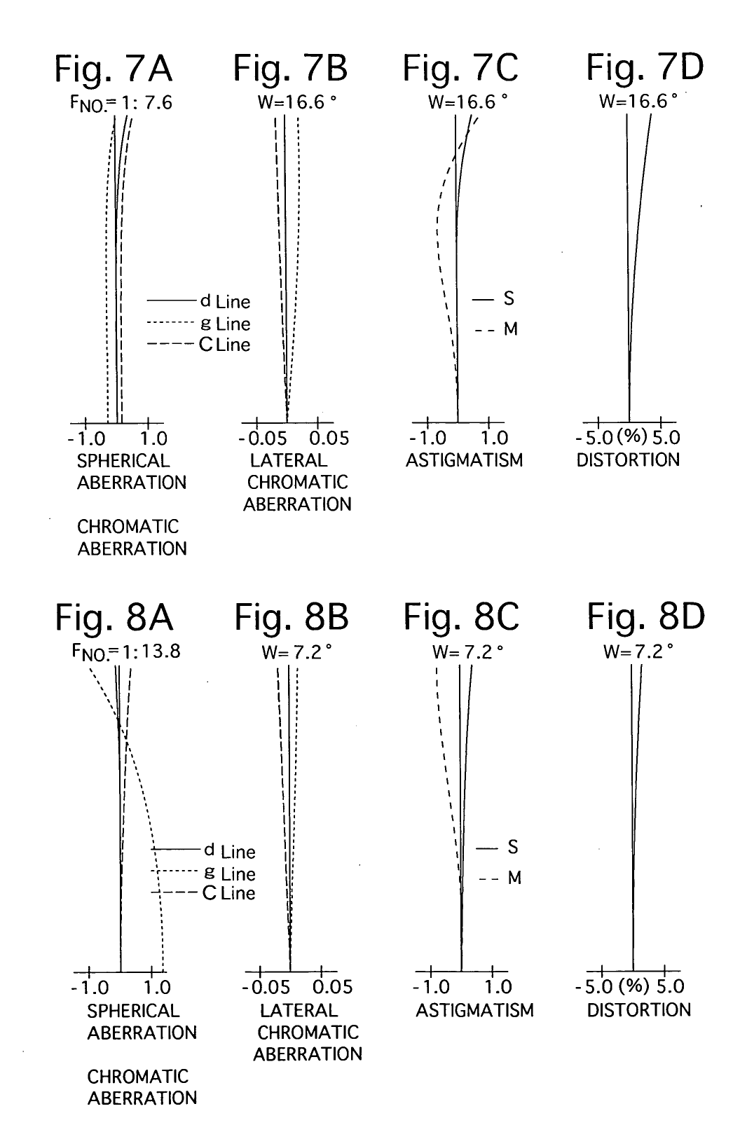

FIG. 5 is the lens arrangement of the zoom lens system according to the second embodiment of the present invention. The second embodiment corresponds to the lens-group moving paths shown in FIG. 16. FIGS. 6A through 6D show aberrations occurred, at the short focal length extremity (fw), in the lens arrangement shown in FIG. 5. FIG. 7A through 7D show aberrations occurred, at an intermediate focal length (fm), in the lens arrangement shown in FIG. 5. FIGS. 8A through 8D show aberrations occurred, at the long focal length extremity (ft), in the lens arrangement shown in FIG. 5. Table 2 shows the numerical data of the second embodiment. The basic lens arrangement of the second embodiment is the same as that of the first embodiment. The diaphragm S is provided 1.16 mm behind (on the image plane side) the third lens group 30 (surface No. 10).

TABLE 2

F_{NO} = 1:5.9-7.6-13.8
f = 39.00-70.00-168.00
W = 28.2-16.6-7.2
fB = 9.42-23.37-63.72

| Surface No. | r | d | Nd | ν |
|---|---|---|---|---|
| 1* | −35.693 | 1.10 | 1.84666 | 23.8 |
| 2 | −76.143 | 0.10 | | |
| 3 | 23.062 | 2.90 | 1.48749 | 70.2 |
| 4 | −54.640 | 2.00-8.07-16.18 | | |
| 5 | −30.282 | 0.90 | 1.80559 | 45.6 |
| 6 | 9.464 | 2.60 | 1.80518 | 25.4 |
| 7 | 36.708 | 5.30-3.00-0.30 | | |
| 8 | 13.439 | 1.10 | 1.84666 | 23.8 |
| 9 | 8.848 | 4.00 | 1.58636 | 60.9 |
| 10* | −23.195 | 15.84-11.03-4.59 | | |
| 11* | 115.364 | 3.00 | 1.58547 | 29.9 |
| 12* | −44.022 | 3.61 | | |
| 13 | −9.832 | 1.20 | 1.72916 | 54.7 |
| 14 | 822.833 | — | | |

*designates the aspherical surface which is
rotationally symmetrical with respect to the optical axis.
Aspherical surface data (the aspherical surface
coefficients not indicated are zero (0.00)):
Surf.

| No. | K | A4 | A6 | A8 |
|---|---|---|---|---|
| 1 | 0.00 | −0.66960 × 10⁻⁵ | 0.74299 × 10⁻⁸ | −0.15201 × 10⁻⁹ |
| 10 | 0.00 | 0.58499 × 10⁻⁴ | −0.14050 × 10⁻⁷ | — |
| 11 | 0.00 | 0.29494 × 10⁻⁵ | −0.11156 × 10⁻⁵ | 0.15343 × 10⁻⁷ |
| 12 | 0.00 | −0.11798 × 10⁻³ | −0.71973 × 10⁻⁶ | — |

### EMBODIMENT 3

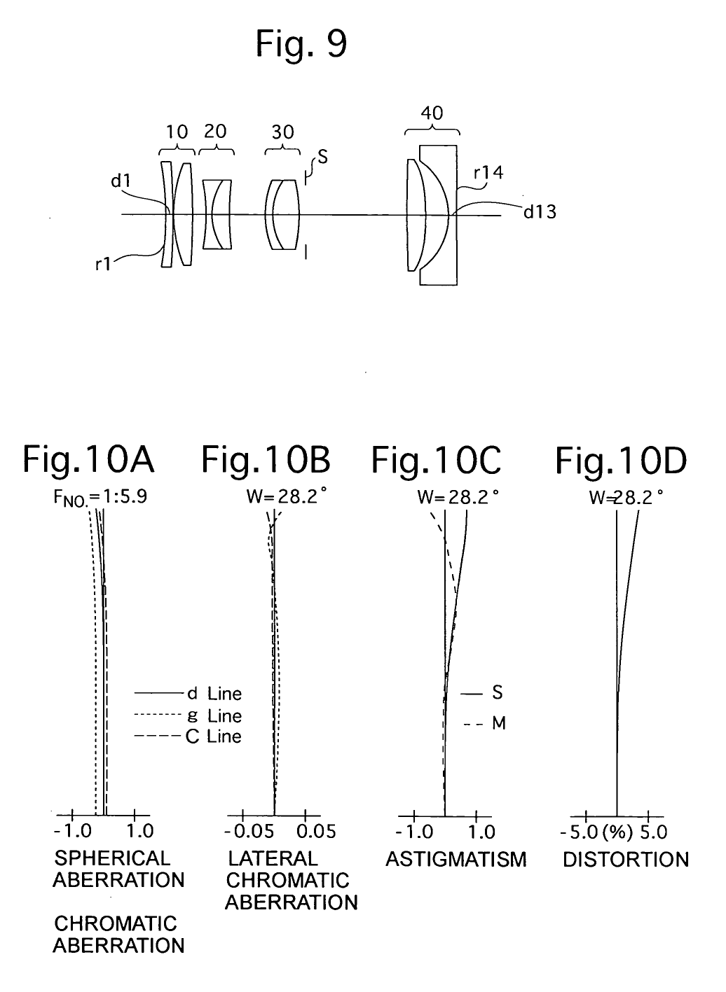

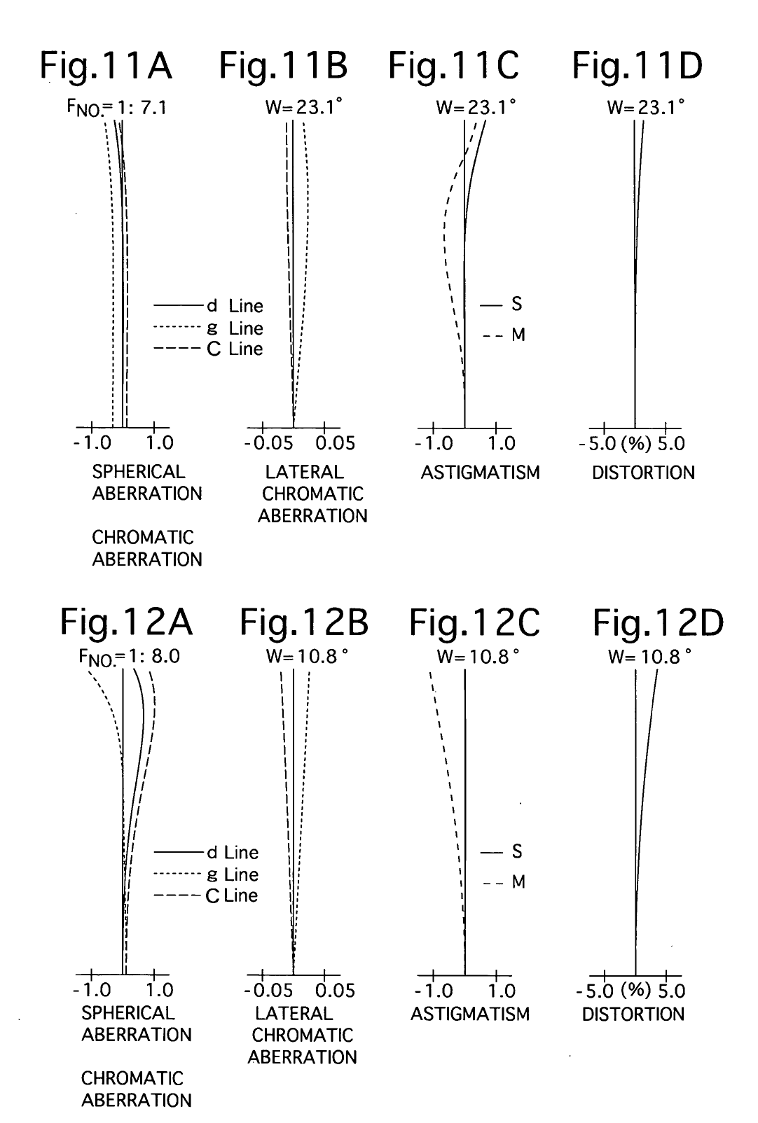

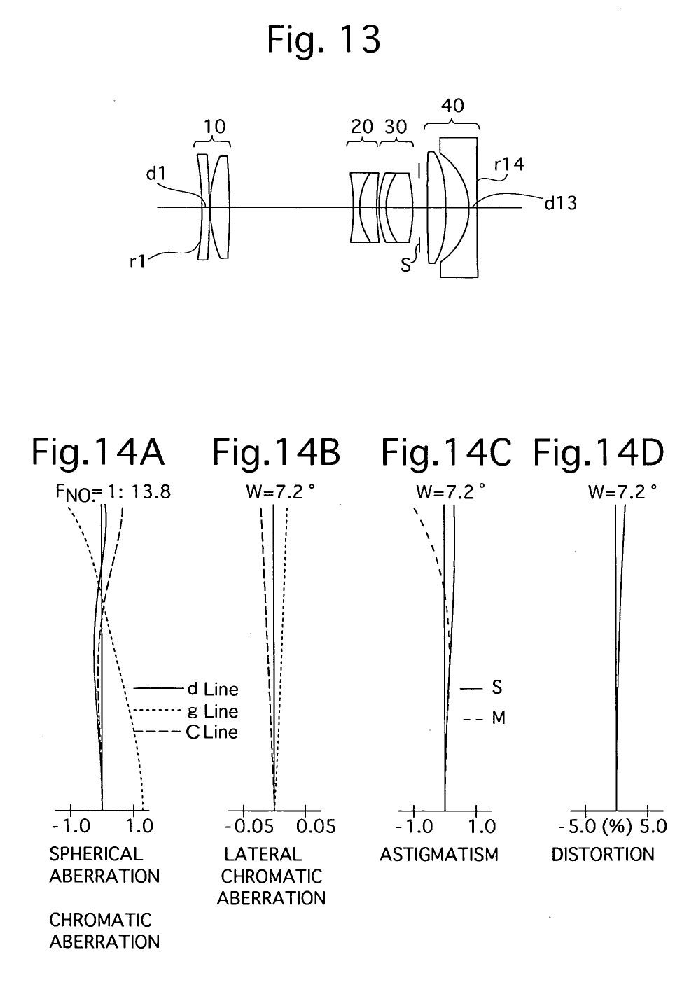

FIG. 9 is the lens arrangement, at the short focal length extremity (fw), of the zoom lens system according to the third embodiment of the present invention. The third embodiment corresponds to the lens-group moving paths shown in FIG. 15. FIGS. 10A through 10D show aberrations occurred in the lens arrangement shown in FIG. 9. FIG. 11A through 11D show aberrations occurred in the lens arrangement shown in FIG. 9 at the first intermediate focal length (fm) (before switching). FIGS. 12A through 12D show aberrations occurred in the lens arrangement shown in FIG. 9 at the second intermediate focal length (fm′) (after switching). FIG. 13 is the lens arrangement, at the long focal length extremity (ft), of the zoom lens system according to the third embodiment of the present invention. FIGS. 14A through 14D show aberrations occurred in the lens arrangement shown in FIG. 13. Table 3 shows the numerical data of the third embodiment.

The values of f, W and fB are each shown in the order of fw-fm-fm′-ft.

The negative second lens group 20 and the positive third lens group 30 maintain the first distance d1 (=5.30) in the focal-length range ZW (the first focal length range; the short-focal-length side zooming range).

The negative second lens group 20 and the positive third lens group 30 maintain the second distance d2 (=0.30) in the focal-length range ZT (the second focal length range; the long-focal-length side zooming range).

The basic lens arrangement of the third embodiment is the same as that of the first embodiment.

The diaphragm S is provided 1.0 mm behind (on the image plane side) the third lens group 30 (surface No. 10).

TABLE 3

F_{NO} = 1:5.9-7.1-8.0-13.8
f = 39.00-50.00-110.00-168.00
W = 28.2-23.1-10.8-7.2
fB = 9.60-16.63-36.92-63.81

| Surface No. | r | d | Nd | ν |
|---|---|---|---|---|
| 1 | −45.957 | 1.10 | 1.84666 | 23.8 |
| 2 | −106.116 | 0.10 | | |
| 3* | 20.580 | 2.90 | 1.48750 | 74.2 |
| 4* | −89.736 | 2.00-4.30-15.30-18.74 | | |
| 5 | −28.848 | 0.90 | 1.83481 | 42.7 |
| 6 | 9.228 | 2.60 | 1.80518 | 25.4 |
| 7 | 44.675 | 5.30-5.30-0.30-0.30 | | |
| 8 | 14.242 | 1.10 | 1.84666 | 23.8 |
| 9 | 9.396 | 4.00 | 1.58636 | 60.9 |
| 10* | −21.575 | 16.23-12.82-6.62-2.20 | | |
| 11* | 138.754 | 2.80 | 1.58547 | 29.9 |
| 12* | −40.109 | 3.43 | | |
| 13 | −10.116 | 1.20 | 1.72916 | 54.7 |
| 14 | 1349.925 | — | | |

*designates the aspherical surface which is
rotationally symmetrical with respect to the optical axis.
Aspherical surface data (the aspherical surface
coefficients not indicated are zero (0.00)):

| Surf. No. | K | A4 | A6 | A8 |
|---|---|---|---|---|
| 3 | 0.00 | −0.18206 × 10⁻⁴ | 0.16244 × 10⁻⁶ | 0.71138 × 10⁻⁹ |
| 4 | 0.00 | −0.10251 × 10⁻⁴ | 0.26722 × 10⁻⁶ | — |
| 10 | 0.00 | 0.60922 × 10⁻⁴ | −0.41691 × 10⁻⁶ | — |
| 11 | 0.00 | −0.24455 × 10⁻⁴ | −0.74270 × 10⁻⁶ | 0.12038 × 10⁻⁷ |
| 12 | 0.00 | −0.13920 × 10⁻³ | −0.38965 × 10⁻⁶ | — |

The first and second embodiments are applied to a zoom lens system having the lens-group moving paths of FIG. 16, while the third embodiment is applied to a zoom lens system having the lens-group moving paths of FIG. 15. On the other hand, it is of course possible to apply the first and second embodiments to a zoom lens system having the lens-group moving paths of FIG. 15, and to apply the third embodiment to a zoom lens system having the lens-group moving paths of FIG. 16.

The numerical values of each condition of each embodiment are shown in Table 4.

TABLE 4

| | Embod. 1 | Embod. 2 | Embod. 3 |
|---|---|---|---|
| Condition (1) | 0.49 | 0.47 | 0.49 |
| Condition (2) | 0.57 | 0.48 | 0.53 |
| Condition (3) | 0.73 | 0.70 | 0.74 |
| Condition (4) | 0.13 | 0.13 | 0.13 |
| Condition (5) | 12.26 | 12.13 | 12.05 |
| Condition (6) | −24.07 | −22.33 | −23.14 |
| Condition (7) | 0.90 | 0.94 | 0.98 |

As can be understood from Table 4, the numerical values of the first through third embodiments satisfy conditions (1) through (7). Furthermore, the various aberrations are adequately corrected at each focal length.

According to the above description, a higher zoom ratio and further miniaturization can be achieved in a zoom lens system of the four-lens-group arrangement, i.e., a positive lens group, a negative lens group, a positive lens group, and a negative lens group, in this order from the object.

1. A zoom lens system comprising a positive first lens group, a negative second lens group, a positive third lens group and a negative fourth lens group, in this order from an object,
wherein zooming is performed by moving each lens group in an optical axis direction;
wherein said zoom lens system satisfies the following conditions:
0.35<log(f_{T23}/f_{W23})/log(fₜ/f_{w})<0.55
0.4<(LD_{W}−LD_{T})/(fₜ/f_{w})<0.7
wherein
f_{23W} designates the combined focal length of said negative second lens group and said positive third lens group at the short focal length extremity;
f_{23T} designates the combined focal length of said negative second lens group and said positive third lens group at the long focal length extremity;
fₜ designates the focal length of the entire zoom lens system at the long focal length extremity;
f_{w} designates the focal length of the entire zoom lens system at the short focal length extremity;
LD_{W} designates the distance from the most object-side surface of said positive first lens group to the most image-side surface of said negative fourth lens group at the short focal length extremity; and
LD_{T} designates the distance from the most object-side surface of said positive first lens group to the most image-side surface of said negative fourth lens group at the long focal length extremity.

2. The zoom lens system according to claim 1, further satisfying the following condition:
0.7<f_{w}/f_{1G}<0.9
wherein
f_{w} designates the focal length of the entire zoom lens system at the short focal length extremity; and
f_{1G} designates the focal length of said positive first lens group.

3. The zoom lens system according to claim 1, further satisfying the following condition:
0.05<(d_{23W}−d_{23T})/f_{w}<0.2
wherein
d_{23W} designates the distance between said negative second lens group and said positive third lens group, i.e., the most image-side surface of said negative second lens group and the most object-side surface of said positive third lens group, at the short focal length extremity; and
d_{23T} designates the distance between said negative second lens group and said positive third lens group, i.e., the most image-side surface of said negative second lens group and the most object-side surface of said positive third lens group, at the long focal length extremity; and
f_{w} designates the focal length of the entire zoom lens system at the short focal length extremity.

4. The zoom lens system according to claim 1, further satisfying the following condition:
11<(TL_{T}−TL_{W})/(fₜ/f_{w})<14
wherein
TL_{W} designates the distance from the most object-side surface of said positive first lens group to the image plane, at the short focal length extremity;
TL_{T} designates the distance from the most object-side surface of said positive first lens group to the image plane, at the long focal length extremity;
fₜ designates the focal length of the entire zoom lens system at the long focal length extremity; and
f_{w} designates the focal length of the entire zoom lens system at the short focal length extremity.

5. The zoom lens system according to claim 1, wherein said positive third lens group comprises at least one aspherical surface that satisfies the following condition:
−40<ΔIₐₛₚ<−10
wherein
ΔIₐₛₚ designates the amount of change of the spherical aberration coefficient due to said aspherical surface in said positive third lens group under the condition that the focal length at the short focal length extremity is converted to 1.0.

6. The zoom lens system according to claim 1, wherein said negative fourth lens group comprises at least one aspherical surface that satisfies the following condition:
0<ΔVₐₛₚ<3
wherein
ΔVₐₛₚ designates the amount of change of the distortion coefficient due to said aspherical surface in said negative fourth lens group under the condition that the focal length at the short focal length extremity is converted to 1.0.
